(19) United States
(12) Patent Application Publication
(10) Pub. No.: US 2005/0221129 A1
(43) Pub. Date: Oct. 6, 2005

(54) Monocrystalline silicon substrate coated with metal-plated layer and perpendicular magnetic recording medium

(76) Inventors: Yu Hamaguchi, Takefu-shi (JP); Toshihiro Tsumori, Takefu-shi (JP); Naofumi Shinya, Takefu-shi (JP)

Correspondence Address: MYERS BIGEL SIBLEY & SAJOVEC, PO BOX 37428, RALEIGH, NC, 27627, US

(21) Appl. No.: 11/092,061

(22) Filed: Mar. 29, 2005

(30) Foreign Application Priority Data
Apr. 5, 2004 (JP) 2004-110608

(51) Int. Cl. G11B 5/667

(52) U.S. Cl. 428/846.1

(57) ABSTRACT

Provided is a monocrystalline Si substrate on which one or more metal films having good adhesion to the Si monocrystalline substrate are formed so that the adhesion is ensured. More specifically, provided is a surface-treated substrate comprising a monocrystalline Si substrate having volume resistivity of 1 to 100 Ω·cm, and at least one metal-plated layer on the monocrystalline Si substrate. The metal-plated layer which faces to the monocrystalline Si substrate preferably comprises at least one metal selected from the group consisting of Ag, Co, Cu, Ni, Pd, Fe and Pt. Furthermore, provided is a perpendicular magnetic recording medium comprising the monocrystalline Si substrate coated with the metal-plated layer.

### BACKGROUND OF THE INVENTION

1. Field of the Invention

The present invention relates to a monocrystalline Si substrate coated with a metal-plated layer and to a magnetic recording medium which comprises the substrate.

2. Description of the Related Art

In the field of magnetic recording, information recording by hard disk devices is indispensable for primary external recording devices for computers such as personal computers for example. As the recording densities of hard disk drives increase, the development of perpendicular magnetic recording types in which even higher density recording is possible is advancing, replacing the conventional longitudinal magnetic recording types of hard disk drives.

In perpendicular magnetic recording, the magnetic field from adjacent bits is in the same direction as the magnetizing direction, forming a closed magnetic circuit between adjacent bits. There is less self-reducing magnetic field (referred to below as a “demagnetizing field”) caused by self magnetization than in the horizontal magnetic recording so that the magnetizing condition is stabilized.

The perpendicular magnetic recording does not require the magnetic film becomes thinner as the recording density increases. From this view, the perpendicular magnetic recording can reduce the demagnetizing field, and secure KᵤV values wherein Kᵤ represents anisotropic energy, in particular the crystalline magnetic anisotropic energy in the case of magnetic recording, and V represents the volume of a unit recording bit. Accordingly, it has stability against magnetization by thermal fluctuations and it can be said that this is a recording method that makes it possible to push the recording limit significantly upward. As recording media, the perpendicular recording media have a high affinity with the horizontal recording media. It is possible to use basically the same technology as was used conventionally in both reading and writing of magnetic recording.

The perpendicular magnetic recording medium comprises, on a substrate, a soft magnetic lining layer (typically permalloy or the like), a recording film (for which candidate materials includes CoCr-based alloy, SmCo amorphous film and multi-layer films of alternating laminated layers of PtCo layers and ultra thin films of Pd and Co), a protective layer, and a lubricating layer. It is necessary that the lining layer of the perpendicular magnetic recording medium is softly magnetic film having a thickness of at least 100 nm to about 500 nm. The soft magnetic lining layer is the conductive path for magnetic flux from the recording film above it, and is also the conductive path for the writing flux from the recording head. Thus, it plays the same function as an iron yoke in the magnetic circuit of a permanent magnet so that it is required to be a thick film.

Compared to the formation of non-magnetic Cr-based under-layer film in a horizontal recording medium, it is not easy to form the soft magnetic lining film in the perpendicular recording medium. Typically, the films constituting a horizontal recording medium are all formed by dry processes (mainly by magnetron sputtering). Film formation by a dry process has been investigated for a perpendicular recording medium as well. However, from the aspect of mass-production and productivity, there are large problems for film formation by dry processing because of process stability, the complexity of parameter settings, and more than anything else, a process speed. Furthermore, for the purpose of achieving higher densities, it is necessary to make the height at which the head floats above the surface of the magnetic disk (the flying height) as low as possible. In the manufacture of the perpendicular magnetic recording medium, it is necessary to cover the substrate with a metal film of such a thickness that it can be leveled by polishing. However, because the adhesion of thick films obtained by a dry process is low, leveling by polishing is very problematic. Thus, various tests were performed to cover a non-magnetic substrate with a metal film by the plating method which can form a thick film more easily than the vacuum deposition.

In order to perform plating for good adhesion by a wet plating, it is very important that material which can act as a catalyst for reducing metal ions in the plating solution exists in large quantities at joint sites between the plating film and the base material. Furthermore, the adhesion strength between the plating film formed and the plated base material depends on a mechanical anchoring effect due to unevenness of the surface of the plated material, or on chemical interactions between the plating film and the plated base material.

For example, in order to plate the surface of material having poor chemical reactivity such as plastic, ceramics or glass, a method for securing adhesion based on mechanical anchoring is widely used. The method comprises steps of roughening the surface of the base material by polishing or the like, immersing the base material into a Pd—Sn colloidal solution so that colloidal particles are adhered to indented parts of the surface, and then plating the base material using the adhered colloids as a catalytic starting point.

When plating onto metals such as Fe or the like, metallic bonds are formed between the plating film and the plated metal just after starting the plating. It is believed that strong adhesion is ensured by generation of an alloy at the atomic level.

On the other hand, a silicon wafer used as the plating base material is particularly reactive with oxygen. Within a few hours after manufacturing, the surface is deactivated because the surface is covered with a natural oxide film of SiO₂, which has low chemical activity. For this reason, it is difficult to form chemical bonds with the plating film. It is widely known that such a natural oxide film of the Si surface can be dissolvably removed by soaking in HF or the like, but the Si surface which has had its natural oxide film removed is oxidized very easily. When it is soaked in the plating solution, the oxide film is formed again by reaction with OH groups in the solution after the removal of oxide film and before the formation of plating film. Thus, a desirable plating film cannot be obtained. Because of this, plating onto a Si substrate is carried out by soaking in a Pd—Sn colloid after roughening the surface of the substrate in a similar manner to that for said plating onto plastic or the like.

### SUMMARY OF THE INVENTION

Contrary to the thought that plating directly onto such Si surfaces was difficult, inventors including those of the present invention found that it is possible to form a metal layer having good adhesion by substitution plating onto a Si monocrystal surface. A patent application for this has been already filed (for example, Japanese Patent Application Unexamined Publication No. 2004-143586). In addition, it became possible to use the plating method for forming a magnetic layer (such as CoNiFe, NiFe, CoFe and NiP) having good soft magnetic properties onto the metal layer. A patent application for this has been already filed (for example, Japanese Patent Application Unexamined Publication No. 2004-146032).

However, when a metallic layer is formed on a Si substrate by plating, there is still room for improving the adhesion between the plating layer and the Si substrate. The present invention provides a monocrystalline Si substrate on which one or more metal films having good adhesion with the Si monocrystalline substrate are formed. Thus, a structure which can ensure that adhesion is presented.

According to the present invention, in order to address such issues, it has been found as a result of in depth investigations that discrepancies in the adhesion between the plating layer and the Si substrate are generated, depending on the Si substrate that is used. It has also been found that in a monocrystalline Si substrate having metal-plated layer attached thereon, the combination of a Si substrate having volume resistivity of 1 to 100 Ω·cm and a metal-plated layer is preferable.

That is, according to the present invention, a surface-treated Si substrate comprising a monocrystalline Si substrate having volume resistivity of 1 to 100 Ω·cm, and at least one metal-plated layer on or above the monocrystalline Si substrate is provided. Furthermore, a perpendicular magnetic recording medium comprising this surface-treated Si substrate is provided.

According to the present invention, the Si substrate having volume resistivity of at least 1 Ω·cm is used in a process for manufacturing the Si substrate comprising at least one metal-plated layer. Then, it is possible to provide a magnetic recording medium comprising a Si substrate having at least one metal-plated layer formed thereon or thereabove (wherein a soft magnetic layer may be also comprised) and a recording layer. Consequently, the magnetic recording medium has good adhesion.

According to the present invention, because the monocrystalline Si substrate having metallic film formed thereon has good adhesion, it is suitable for the applications of wires for solar batteries, micro-machines formed on Si substrates and others. It is also suitable for use as a substrate for a magnetic recording medium by forming a magnetic film on the metal film.

### DETAILED DESCRIPTION OF THE PREFERRED EMBODIMENTS

The present invention is described more specifically below.

According to the present invention, it has been found that the combination of a monocrystalline Si substrate having volume resistivity of 1 to 100 Ω·cm and at least one metal-plated layer is preferable for the Si substrate having at least one metal-plated layer formed thereon.

When at least one metal-plated layer is formed on the monocrystalline Si substrate by a plating method, if the volume resistivity of the Si substrate is 1 to 100 Ω·cm, then the Si substrate having at least one metal-plated layer formed thereon reliably have good adhesion.

The Si substrate to be used in the present invention may be preferably a Si monocrystalline material which has been preferably manufactured by the CZ (Czochralski) process or the FZ (Floating Zone) method. The substrate manufactured by the CZ process may be more preferable because it is easier to fabricate a large diameter substrate.

The volume resistivity of the monocrystalline Si substrate may be 1 to 100 Ω·cm. When the volume resistivity is lower than 1 Ω·cm, the adhesion between the metal-plated layer and the Si substrate is poor so that the layer easily delaminates. It may be more preferably 5 to 50 Ω·cm.

The surface orientation of the monocrystalline Si substrate may be (100), (110) or (111). When the monocrystalline Si substrate has one of these surface orientations, then there is no one orientation that has a dominant adhesive force. Even more preferable may be a (110) surface, which is most widely used, in which the orientation has an allowable lean of ±10°. However, when polycrystalline Si is selected as the substrate, the metal-plated layer formed is not uniform due to differences in the substrate strength and in the chemical reactivity. Thus, polycrystalline Si is not suitable according to the present invention.

The metal-plated layer may not be limited to a single layer but may be a plurality of layers including the layer which directly contacts the surface of the substrate. Among at least one metal-plated layer which is formed on the Si monocrystalline substrate, the metal-plated layer which faces to the Si monocrystalline substrate is called as the “nucleation layer”. The nucleation layer may preferably comprise at least one metal selected from the group consisting of Ag, Co, Cu, Ni, Pd, Fe and Pt, or may preferably comprise an alloy or a compound comprising the metal. The examples of the alloy may include NiFe and NiCu and the examples of the compound may include NiFeB and NiFeP.

Furthermore, it is also possible to use a compound such as NiP in which P is incorporated into Ni. Even more preferable may be a nucleation film in which Ni is comprised as the principal component because of relative ease for forming a film which has good adhesion.

It is not necessary that the nucleation layer is a single layer and it may be a multi-layer such as Ni/Cu, Ni/Ag, Ni/Co, Pd/Cu, Pd/Ag and Pd/Ni/Cu.

The boundary surface between the monocrystalline Si substrate and the nucleation layer may not be what can be clearly delineated. For example, in the case of a Ni nucleation film, it may have a boundary surface structure like Si/SiO(Si)+Ni/Ni. The transition region of SiO(Si)+Ni shifts steadily from the Si rich substrate side via an Ni rich condition to the pure Ni nucleation film.

The metal-plated layer provided on the Si monocrystal substrate is not limited to the nucleation layer, but may also comprise a soft magnetic layer above or on the nucleation layer. A Si monocrystalline substrate comprising at least one metal-plated layer and at least one soft magnetic layer may be used as a surface-treated substrate for a perpendicular magnetic recording medium.

For this application, it may be necessary that both surfaces of the monocrystalline Si substrate have the same structure, and substantially same thickness, composition and magnetic properties. That is, the metal-plated layers are provided on both sides of the monocrystalline Si substrate so that the thickness, composition and magnetic properties of the metal-plated layers are symmetrical surfaces with respect to a plane of the monocrystalline Si substrate. The formation of a film or films which have the same characteristics onto both sides can increase the capacity per single Si substrate on comparison with only a single side.

According to the present invention, a soft magnetic layer is formed by plating and it may preferably have a coercive force of 50 oersteds (Oe) or less. When a coercive force is more than 50 oersteds, the soft magnetic properties may disappear so that the magnetic recording under-layer and especially the soft magnetic under-layer for perpendicular recording may fail to function. It is desirable that the coercive force is as small as possible, but the minimum coercive force that can be realized in practice may be about 0.1 oersteds. Provided that the magnetic film is formed by a plating method, any soft magnetic material may be suitable. The soft magnetic film may include a material such as CoNiFe, NiFe (permalloy), FeCo and NiCo which can satisfy the above-noted range of coercive force. If one or more components such as S, B, C, O, F, Mg, Al, Si, P, Ti, V, Cr, Mn, Cu, Zn, Ga, Ge, Y, Zr, Nb, Mo, Ru, Rh, Pd, Ag, In, Sn, Sb, La, Ce, Pr, Nd, Pm, Sm, Eu, Gd, Tb, Dy, Ho, Er, Tm, Yb, Lu, Hf, Ta, W, Re, Os, Ir, Pt or Au are incorporated from the plating solution into the soft magnetic film at a composition of 5 mass % or less, then their influence on the soft magnetic properties may be small, and at that level, the influence may be allowable.

According to the present invention, it is possible to activate the substrate surface which may be required for forming a metal-plated layer by lightly etching the surface oxide layer of the monocrystalline Si substrate or the substrate surface.

The substrate surface may be preferably etched in an alkali solution such as a caustic potassium hydroxide solution and/or a caustic soda solution of a concentration of 2 to 60% by weight. It is preferable to remove the oxide layer of the substrate and lightly corrode the substrate surface. A preferable speed for etching the base material for imparting activity may be 20 nm/min to 5 μm/min. As for the etching amount, it may be preferable to remove at least 40 nm of base material Si. The temperature of the solution during etching depends on the concentration and processing time, but a range of 30 to 100° C. may be preferable from the point of view of operability.

Next, the Si substrate is hydrophilicly treated after etching, but the hydrophilic treatment is preferably performed using alcohol or hydrogen peroxide.

Alcohol such as ethylene glycol, ethanol and isopropyl alcohol may be suitable for use. An aqueous solution of 1 to 20 weight % may be suitable for use as the hydrogen peroxide.

A hydrophilic treatment may be performed, for example, by immersing the etched Si substrate into alcohol or hydrogen peroxide. The time and temperature of the hydrophilic treatment may change depending on the number of objects to be treated and the volume of the treatment bath. They may be preferably 30 seconds to 10 minutes at 15 to 80° C. The Si substrate that has been hydrophilically treated increases adhesivity with respect to the metal-plated layer formed thereon it, and imparts good uniformity in formation of film on a non-magnetic base.

After such etching and hydrophilic treatment, a highly adhesive plating material is obtained by immersion in a plating solution which contains metallic ion (ions) or main metallic ion (ions) of one or more metals selected from the group consisting of Ag, Co, Cu, Ni, Pd, Fe and Pt, or one or more alloys or compounds comprising said one or more metals. The concentration of the metallic ion (ions) in the plating solution may be at least 0.01 N, more preferably 0.05 to 0.3N on basis of elemental component.

The thickness of the metal-plated layer may be preferably 10 to 1000 nm, more preferably 50 to 500 nm. When the thickness is less than 10 nm, it may not have a uniform distribution of the metallic polycrystal particles. When the thickness is more than 1000 nm, the individual crystal particle is enlarged so that it may not be suitable as an under-layer.

The formation of the nucleation layer is described in further detail.

The nucleation layer may be preferably formed by a method that is generally known as non-electrolytic substitution plating. The solution may be similar to that for the conventional substitution plating so that it does not contain a reducing agent such as hypophosphoric acid or hypochloric acid. However, according to the present invention, it may be preferable to use a sulfate bath which does not contain saccharin or the like which is a glossing material. Examples of the sulfate may include nickel sulfate and copper sulfate. The preferable concentration of the sulfate may be 0.01 to 0.5 N. A bath containing a hydrochloride solution or a bath containing at least 0.05 N chloride ions may not be preferable because it is difficult to obtain the metal-plated layer of the present invention and there may be cases in which plating onto a Si substrate itself becomes impossible. Furthermore, it may not be preferable in terms of performing the present invention that each element such as K, Ca and Na is present in the solution at concentration of 0.003 N or greater. Consequently, it may be preferable that chloride ion is present at less than 0.05 N, and elements such as K, Ca and Na are each present at less than 0.003 N.

The plating conditions for forming the nucleation layer may include a solution temperature of 70 to 100° C., and a pH of the bath (solution) that is in a range of 7 to 10, more preferably 7.5 to 9. When the temperature of the plating solution is less than 70° C., plating may not be possible. When the temperature of the plating solution is more than 100° C., or when the pH of the solution is outside the above range, although plating itself is possible, the metal-plated layer of the present invention may not be obtained. It is preferable that the pH is adjusted by addition of ammonia. When the pH is adjusted by hydroxide such as caustic soda, even if the pH is adjusted to be within the above range, it may still be difficult to achieve the present invention. The reason for this is not absolutely clear, but it seems that chelation of the metal ion in solution with a chelate-forming agent such as ammonia is exceedingly important.

It is sufficient that the amount of ammonia to be added is appropriately adjusted depending on an initial pH value. The ammonia may be added such that the concentration in the plating bath is about 0.02 N to 0.5 N, preferably 0.05 N to 0.2 N.

The metal-plated layer can be formed by combining the above-noted etching and metal plating processes.

The soft magnetic plating layer may be preferably formed by a method which is generally known as non-electrolytic substitution plating. A sulfate bath or a chloride bath may be used for non-electrolytic plating, and a variety of metals may be used in the bath (solution). However, because of the need to generate magnetic properties and to obtain cubic crystals, it may be necessary to use one or more metal salts which contain one or more elements selected from the group consisting of Co, Ni and Fe so that an alloy plating layer that contains at least two of these elements is formed.

The Co, Ni and Fe can be non-electrolytically plated, and in order to realize the present invention it may be preferable that these elements are comprised because of their favorable properties as soft magnetic materials.

More specifically, the composition of the bath preferably may comprise at least two metallic ions selected from nickel, cobalt and iron. The examples may include a mixed bath of nickel sulfate and cobalt sulfate, and a mixed bath further comprising iron sulfate. The concentration may be preferably 0.01 to 0.5 N.

The reducing agent in non-electrolytic plating may include hypophosphoric acid, dimethylamine borane, and other various compounds and may be selected depending on a metal ion which is present in the bath.

The magnetic recording medium of the present invention may be produced by forming the above soft magnetic layer having a thickness of 100 to 1000 nm, then forming a 5 to 100 nm magnetic recording layer on or above it, and then preferably forming a 2 to 20 nm protection layer and/or a 2 to 20 nm lubrication layer in that order.

When the thickness of the soft magnetic layer is more than 1000 nm, it may not be preferable because the magnetic noise from the soft magnetic layer may be significant during the reproduction of the signal so that the S/N ratio reduces its performance as a medium. When the thickness is less than 100 nm, it may not be preferable because the magnetic permeation characteristics of the soft magnetic under-layer may not be sufficient so that over-write characteristics of the medium decline.

The magnetic recording layer on or above the soft magnetic layer may comprise a hard magnetic material in order to perform magnetic recording.

The recording layer may be formed directly on the soft magnetic layer, or may be formed after placement of one or more intermediate layers such as Ti if it is necessary to control the particle diameters of the crystals and the magnetic properties.

The hard magnetic material for the recording layer is not particularly limited as long as it comprises magnetic domains that are easily magnetized in a direction perpendicular to the layer plane. It may include Co—Cr alloy film formed by sputtering, Fe—Pt alloy film, Co—Si granule film, Co/Pd multi layer film and various others. It may also include film formed by a wet method such as a Co—Ni-based plated layer, and film formed by coating such as film of barium ferrite comprising a magneto plumbite phase.

The thickness of such a recording layer may be about 5 to 1000 nm, more preferably 10 to 50 nm. The coercive force may be 0.5 to 10 KOe, more preferably 1.5 to 3.5 KOe.

The protective layer formed on the recording layer may comprise an amorphous C-type protective layer formed by a sputtering or CVD method, and a crystalline protective layer such as Al₂O₃.

The uppermost lubrication layer may comprise a mono-molecular film formed by coating a fluorine-based oil, and there is no particular limitation to the type of agent or coating method.

The present invention will be described below based on examples. However, it should not be construed that the present invention is limited to them.

### Examples 1 to 5 and Comparative Examples 1 to 7

A (100) Si monocrystalline substrate (a B-doped P-type substrate) having a diameter of 65 mm and having a surface roughness (Rms) of 0.5 nm for both surface was prepared as a Si substrate for the formation of metal-plated layer by a known method of cutout, edge-removal and lapping of a Si monocrystalline substrate having diameter of 200 mm fabricated by the CZ (Czochralski) method, followed by the polish of both surfaces with colloidal silica having an average particle size of 15 nm. The Rms represents the mean square roughness and was measured using an AFM (atomic force microscope).

The substrate was immersed in a 45° C. aqueous 10 wt % caustic soda solution for 10 minutes to remove the thin oxide surface layer on the surface of the substrate, and treated for Si-etching on the surface. Then, an under-plating bath was prepared by adding 0.5 mol/dm³ ammonium sulfate to a 0.1 mol/dm³ aqueous solution of nickel sulfate. The under-plated layer was formed by heating the bath to 80° C. and immersing the substrate for 5 minutes.

Moreover, a plating bath (solution) containing 0.2 N ammonium sulfate, 0.02 N iron sulfate, 0.07 N cobalt sulfate and 0.04 N dimethylamine borane as the reducing agent was prepared. A soft magnetic layer was formed by heating the plating bath (solution) to 65° C. and immersing the substrate with the under-layer for 15 minutes.

When the magnetic property of the soft magnetic plating layer obtained was measured using a VSM (vibrating sample magnetometer), the coercive force was 42 oersteds (Oe).

The adhesion of the metal-plated layer obtained was tested using a crosscut exfoliation tester (MODEL AD-1110, manufactured by Ueshima Seisakusho Corporation) based on JIS K5400 (grid test).

### Examples 6 to 10 and Comparative Examples 8 to 14

Apart from use of a Si monocrystalline substrate having a diameter of 200 mm fabricated by the CZ method as the Si substrate for the formation of the metal-plated layer, use of an aqueous solution of caustic soda for the etching treatment, and use of an under-plating bath of 0.1 mol/dm³ aqueous solution of nickel sulfate, the metal-plated layer shown in Table 1 was obtained in the same manner as in Example 1. The adhesion test was carried out in the same manner as in Example 1.

### Examples 11 to 15 and Comparative Examples 15 to 20

Apart from use of a Si monocrystalline substrate having a diameter of 200 mm fabricated by the CZ method as the Si substrate for the formation of the metal-plated film, and use of an aqueous 0.01 to 0.5 mol/L solution of copper nitrate and nickel sulfate, the metal-plated layer shown in Table 1 was obtained in the same manner as in Example 1. The adhesion test was carried out in the same manner as in

### Example 1

Adhesion Test

In order to measure the adhesion of the film, the surface of a 20 mm×20 mm test piece was scratched to form eleven parallel lines having a pitch of 0.5 mm using steel nails to which a predetermined load (240 g) was applied. Then, the test piece was rotated by 90° and scratched again to form eleven lines. Of 100 grids, the number in which delamination occurred was measured.

Explanation of the Results

The results are shown in Table 1. As a result of examining the relationship of the adhesion of the metal-plated layer to the substrate with respect to the volume resistivity of the Si substrate, it was found when the volume resistivity of the Si substrate increased, the number of grids which had been delaminated decreased according to the delamination results. In particular, when the volume resistivity of the Si substrate exceeded 0.010 Ω·cm, the number of grids which had been delaminated decreased sharply. No film delamination was observed in samples having a volume resistivity of at least 1 Ω·cm. Furthermore, when the volume resistivity of the Si substrate exceeded 100 Ω·cm, delamination of the film was observed. According to this result, when a Si substrate having volume resistivity of 1 to 100 Ω·cm is used in a process for manufacturing the surface-treated Si substrate comprising a metal-plated layer, a magnetic recording medium having good adhesion can be provided, the magnetic recording medium comprising the Si substrate, the metal-plated layer (which may also comprise a soft magnetic layer) and a recording layer.

TABLE 1

| | | volume resistivity | number of grids |
|---|---|---|---|
| | metal layer | (Ω · cm) | delaminated |
| Example 1 | Cu | 2.3 | 0 |
| Example 2 | Cu | 9.4 | 0 |
| Example 3 | Cu | 14 | 0 |
| Example 4 | Cu | 20 | 0 |
| Example 5 | Cu | 95 | 0 |
| Example 6 | Ni | 4.8 | 0 |
| Example 7 | Ni | 9.7 | 0 |
| Example 8 | Ni | 13 | 0 |
| Example 9 | Ni | 21 | 0 |
| Example 10 | Ni | 90 | 0 |
| Example 11 | Ni and Cu | 3.2 | 0 |
| Example 12 | Ni and Cu | 10 | 0 |
| Example 13 | Ni and Cu | 16 | 0 |
| Example 14 | Ni and Cu | 20 | 0 |
| Example 15 | Ni and Cu | 97 | 0 |
| Comp. Ex. 1 | Cu | 6.1 × 10⁻³ | 100 |
| Comp. Ex. 2 | Cu | 8.4 × 10⁻³ | 95 |
| Comp. Ex. 3 | Cu | 11 × 10⁻³ | 12 |
| Comp. Ex. 4 | Cu | 13 × 10⁻³ | 5 |
| Comp. Ex. 5 | Cu | 15 × 10⁻³ | 3 |
| Comp. Ex. 6 | Cu | 20 × 10⁻³ | 2 |
| Comp. Ex. 7 | Cu | 125 | 9 |
| Comp. Ex. 8 | Ni | 5.2 × 10⁻³ | 100 |
| Comp. Ex. 9 | Ni | 7.1 × 10⁻³ | 100 |
| Comp. Ex. 10 | Ni | 10 × 10⁻³ | 9 |
| Comp. Ex. 11 | Ni | 13 × 10⁻³ | 7 |
| Comp. Ex. 12 | Ni | 15 × 10⁻³ | 4 |
| Comp. Ex. 13 | Ni | 19 × 10⁻³ | 1 |
| Comp. Ex. 14 | Ni | 140 | 8 |
| Comp. Ex. 15 | Ni and Cu | 5.2 × 10⁻³ | 100 |
| Comp. Ex. 16 | Ni and Cu | 7.1 × 10⁻³ | 100 |
| Comp. Ex. 17 | Ni and Cu | 10 × 10⁻³ | 15 |
| Comp. Ex. 18 | Ni and Cu | 12 × 10⁻³ | 4 |
| Comp. Ex. 19 | Ni and Cu | 15 × 10⁻³ | 3 |
| Comp. Ex. 20 | Ni and Cu | 21 × 10⁻³ | 1 |
| Comp. Ex. 21 | Ni and Cu | 133 | 10 |

1. A surface-treated Si substrate, comprising:
a monocrystalline Si substrate having volume resistivity of 1 to 100 Ω·cm, and at least one metal-plated layer provided on or above the Si substrate.

2. The surface-treated Si substrate according to claim 1, wherein
said at least one metal-plated layer which faces to said monocrystalline Si substrate comprises at least one metal selected from the group consisting of Ag, Co, Cu, Ni, Pd, Fe and Pt, or is an alloy or a compound comprising the metal.

3. The surface-treated Si substrate according to claim 1 wherein
said at least one metal-plated layer comprises two or more layers and at least one of the metal-plated layers is a ferromagnetic layer having a soft magnetic property of a coercive force of 50 oersteds or less.

4. The surface-treated Si substrate according to claim 2 wherein
said at least one metal-plated layer comprises two or more layers and at least one of the metal-plated layers is a ferromagnetic layer having a soft magnetic property of a coercive force of 50 oersteds or less.

5. The surface-treated Si substrate according to claim 1 wherein
said at least one metal-plated layer is provided on both surfaces of said monocrystalline Si substrate so that thicknesses, compositions and magnetic properties of the metal-plated layers are symmetrical with respect to a plane of the Si monocrystalline substrate.

6. The surface-treated Si substrate according to claim 2 wherein
said at least one metal-plated layer is provided on both surfaces of said monocrystalline Si substrate so that thicknesses, compositions and magnetic properties of the metal-plated layers are symmetrical with respect to a plane of the Si monocrystalline substrate.

7. The surface-treated Si substrate according to claim 3 wherein
said at least one metal-plated layer is provided on both surfaces of said monocrystalline Si substrate so that thicknesses, compositions and magnetic properties of the metal-plated layers are symmetrical with respect to a plane of the Si monocrystalline substrate.

8. The surface-treated Si substrate according to claim 4 wherein
said at least one metal-plated layer is provided on both surfaces of said monocrystalline Si substrate so that thicknesses, compositions and magnetic properties of the metal-plated layers are symmetrical with respect to a plane of the Si monocrystalline substrate.

9. A perpendicular magnetic recording medium comprising a surface-treated Si substrate according to claim 1.

10. A perpendicular magnetic recording medium comprising a surface-treated Si substrate according to claim 4.

11. A perpendicular magnetic recording medium comprising a surface-treated Si substrate according to claim 6.

12. A perpendicular magnetic recording medium comprising a surface-treated Si substrate according to claim 7.

13. A perpendicular magnetic recording medium comprising a surface-treated Si substrate according to claim 8.
